(19) United States
(12) Patent Application Publication
(10) Pub. No.: US 2014/0065401 A1
(43) Pub. Date: Mar. 6, 2014

(54) GLASS ARTICLES WITH HIGH FLEXURAL STRENGTH AND METHOD OF MAKING

(71) Applicant: Corning Incorporated, Corning, NY (US)

(72) Inventors: Michael Patrick Donovan, Painted Post, NY (US); Anthony John Furstoss, Corning, NY (US); Kyle C. Hoff, Painted Post, NY (US)

(73) Assignee: Corning Incorporated, Corning, NY (US)

(21) Appl. No.: 14/011,146

(22) Filed: Aug. 27, 2013

Related U.S. Application Data
(60) Provisional application No. 61/695,613, filed on Aug. 31, 2012.

(51) Int. Cl. C03C 21/00; C03C 15/02

(52) U.S. Cl. CPC C03C 21/002; C03C 15/02
USPC 428/220; 428/410; 65/31; 65/30.14

(57) ABSTRACT

A strengthened glass article has a chemically-etched edge and a compressive stress layer formed in a surface region thereof. The compressive stress layer has a compressive stress and a depth of layer. A product of the compressive stress and depth of layer is greater than 21,000 μm-MPa. A method of making the strengthened glass article includes creating the compressive stress layer in a glass sheet, separating the glass article from the glass sheet, and chemically etching at least one edge of the glass article.

This application claims the benefit of priority under 35 U.S.C. §119 of U.S. Provisional Application Ser. No. 61/695,613 filed on 31 Aug. 2012 the content of which is relied upon and incorporated herein by reference in its entirety.

### FIELD

The present disclosure relates to methods of strengthening glass and strengthened glass articles.

### BACKGROUND

Glass is desirous for use as covers in display-based electronic devices. The glass cover can protect the displays of the electronic devices while allowing viewing of and interaction with the displays. Typically, the process of making the cover glasses involves producing a glass sheet and then creating a plurality of glass articles from the glass sheet. Creating the plurality of glass articles from the glass sheet involves separating a plurality of glass articles from the glass sheet. After the separation, the glass articles are typically machined. The reasons for machining may be to reduce or eliminate the roughness of the edges of the glass articles that resulted from the separation, to shape the edges into a desired profile, and/or to form features such as notches in the edges.

Cover glasses are required to be resistant to damage from contact damage and simultaneous or subsequent flexural stress. This requirement is normally met by strengthening the glass using chemical tempering, e.g., ion-exchange or ion-stuffing process, or thermal tempering. There are two routes to incorporating a strengthening process into production of glass articles. The first route involves separating a plurality of glass articles from the glass sheet, machining the glass articles, and then subjecting the glass articles to a strengthening process. The second route involves strengthening the glass sheet, separating a plurality of glass articles from the strengthened glass sheet, and then machining the glass articles. The second route allows surfaces of the glass sheet to be protected prior to separation and machining, which may involve contact of solid tools with the glass that can induce surface flaws in the glass.

If the second route is taken, the glass article separated from a strengthened glass sheet will have surfaces with residual compressive stress and edges that are largely free of residual compressive stress. After these edges are subjected to machining, they will exhibit low strength compared to the surfaces. This is partly due to flaws such as chips and cracks induced in the edges by the machining and also due to the edges being largely free of residual compressive stress. The low fracture strength of the edges will define the overall fracture strength of the glass article. That is, to prevent failure of the glass article due to flexural stress, the glass article strength will be limited by the edge flexural strength.

### SUMMARY

The present disclosure provides a strengthened glass article having a chemically-etched edge and a compressive stress layer having a compressive stress and a depth of layer, where a product of the compressive stress and depth of layer is greater than 21,000 μm-MPa.

In particular embodiments, the present disclosure provides a strengthened glass article having a uniaxial flexural strength in excess of 600 MPa, a chemically-etched edge, and a compressive stress layer having a compressive stress and a depth of layer, where a product of the compressive stress and depth of layer is greater than 21,000 μm-MPa and the depth of layer is at least 31 μm.

In particular embodiments, the present disclosure provides a strengthened glass article having a uniaxial flexural strength in excess of 600 MPa, a chemically-etched edge, and a compressive stress layer having a compressive stress and a depth of layer, where a product of the compressive stress and depth of layer is greater than 21,000 μm-MPa and the compressive stress is greater than 600 MPa.

In particular embodiments, the present disclosure provides a strengthened glass article having a chemically-etched edge, a compressive stress layer having a compressive stress of at least 650 MPa and a depth of layer greater than 35 μm.

In particular embodiments, the present disclosure provides a strengthened aluminosilicate glass article having a uniaxial flexural strength greater than 650 MPa, a chemically-etched edge, and a compressive stress layer having a compressive stress of at least 650 MPa and a depth of layer greater than 35 μm.

In particular embodiments, the present disclosure provides a strengthened glass article having a uniaxial flexural strength in excess of 600 MPa, a chemically-etched edge, and a failure location under uniaxial flexure displaced from outer fiber flexural tensile stress by at least 20 μm.

In particular embodiments, the present disclosure provides a strengthened alkali aluminosilicate glass article having a uniform thickness in a range from 0.2 mm to 2 mm, a chemically-etched edge, a compressive stress layer having a compressive stress and a depth of layer, where a product of the compressive stress and depth of layer is greater than 21,000 μm-MPa and the depth of layer is greater than 35 μm.

The present disclosure also provides methods of making strengthened glass articles comprising (i) creating a compressive stress layer in a glass sheet such that a product of a compressive stress in the compressive stress layer and a depth of the compressive stress layer is greater than 21,000 μm-MPa, (ii) separating a glass article from the glass sheet, and (iii) chemically etching at least one of the edges of the glass article. In particular embodiments of the disclosed methods, the step of creating the compressive stress is for a duration and under conditions to achieve a compressive stress of at least 650 MPa and a depth of compressive stress layer greater than 35 μm.

It is to be understood that both the foregoing general description and the following detailed description are exemplary of the invention and are intended to provide an overview or framework for understanding the nature and character of the invention as it is claimed. The accompanying drawings are included to provide a further understanding of the invention and are incorporated in and constitute a part of this specification. The drawings illustrate various embodiments of the invention and together with the description serve to explain the principles and operation of the invention.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a cross-section of a strengthened glass sheet.

FIG. 2 is a cross-section of a glass article separated from a strengthened glass sheet.

FIG. 3 is a cross-section of a finished glass article having rounded edges.

FIG. 4. is a plot of failure probability versus flexural strength.

FIG. 5 is a plot of flexural strength at 10% failure probability and Weibull modulus versus depth of compressive stress layer.

FIG. 6A is a setup for a horizontal four-point bend test.

FIG. 6B is a cross-section of a glass article showing maximum tension and compression in uniaxial flexure.

FIG. 7A is a fractured glass surface with fracture location displaced by approximately 20 μm from outer fibers of the glass.

FIG. 7B is a fractured glass surface with fracture location displaced by approximately 95 μm from outer fibers of the glass.

FIG. 7C is a fractured glass surface with fracture location displaced by approximately 100 μm from outer fibers of the glass.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. In addition, like or identical reference numerals may be used to identify common or similar elements.

In brittle materials such as glass, fracture takes place initially at a flaw or microscopic crack in the material and then rapidly spreads across the material. The flexural strength of the material is a function of the largest critical flaw under tensile stress. The critical flaw is determined by the applied stress over the length of the flaw, the stress intensity factor at the tip of the flaw, and the fracture toughness of the glass. The tensile stress required for failure increases as the flaw size reduces or the stress intensity factor at the tip of the flaw decreases. The tensile stress required for failure is further increased if that flaw is under residual compressive stress. In the present disclosure, knowledge of brittle fracture mechanisms and other discoveries are used to develop glass articles with relatively high uniaxial flexural strengths, as measured by a horizontal four-point bend test.

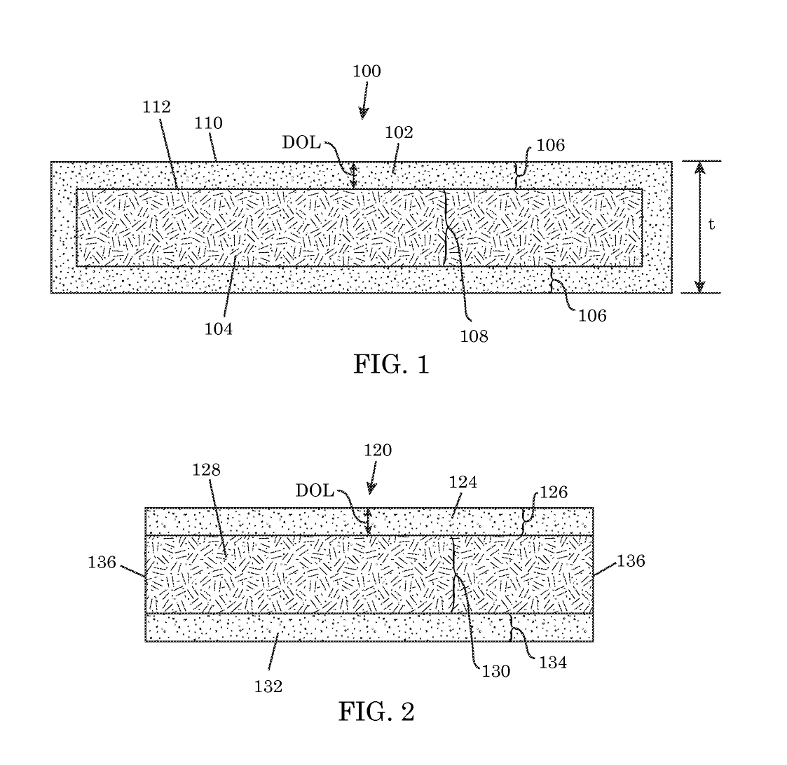

FIG. 1 shows a strengthened glass sheet 100 from which glass articles according to the present disclosure are prepared. The strengthened glass sheet 100 has a compressive stress layer 102 and a tensile stress layer 104. The compressive stress layer 102 is located in the outer surface region 106 of the glass sheet, while the tensile stress layer 104 is located in the inner core region 108 of the glass sheet. The inner core region 108 is adjacent to the outer surface region 106 and may be completely enclosed within the outer surface region 106. The depth of the compressive stress layer, or simply depth of layer, DOL is measured from the surface 110 of the glass sheet to the boundary 112 between the compressive stress layer 102 and the tensile stress layer 104. At boundary 112, compressive stress in the glass sheet is zero. The compressive stress in the compressive stress layer 102, the central tension in the tensile stress layer 104, and the depth of the compressive stress layer DOL are interrelated. The relationship is given by:

$$CT = \frac{( CS \times DOL )}{( t - 2 \times DOL )} \qquad ( 1 )$$

where CT is central tension in the tensile stress layer 104, CS is compressive stress in the compressive stress layer 102, DOL is depth of the compressive stress layer 102, and t is thickness of the glass sheet.

The compressive stress layer 102 is created in the outer surface region 106 by a tempering process, which may be chemical or thermal. In a preferred embodiment, chemical tempering is used to create the compressive stress layer 102 in the outer surface region 106. In some specific embodiments, the chemical tempering is a low-temperature ion-exchange process, where smaller cations in the outer surface region 106 are replaced by larger cations from an external source. This process may also be referred to as ion-stuffing. The larger cations when stuffed into the outer surface region 106 will take up more space than the displaced smaller cations. Because the outer surface region 106 is constrained by the adjacent inner core region 108, the outer surface region 106 will not be able to expand. Instead, the outer surface region 106 will develop compressive stress, which will be balanced by tensile stress in the inner core region 108. The glass sheet 100 is strong because flaws normally grow under tension in brittle materials and stresses applied to the strengthened glass sheet 100 will have to overcome the residual compressive stress in the outer surface region 106 before the glass sheet 100 can fail.

FIG. 2 shows a glass article 120 separated from the strengthened glass sheet 100 (in FIG. 1). The body of the glass article 120 has top surface region 126, a core region 130, a bottom surface region 134, and edges 136. The core region 130 is between and adjacent to the top surface region 126 and the bottom surface region 134. A top compressive stress layer 124 is located in the top surface region 126, a tensile stress layer 128 is located in the core region 130, and a bottom compressive stress layer 132 is located in a bottom surface region 134. Techniques such as scribing and breaking, mechanical cutting, or laser cutting may be used to separate the glass article 120 from the strengthened glass sheet. The separation results in the tensile stress layer 128 being exposed at the edges 136 of the glass article 120.

After the separation, the edges 136 are finished by machining. Techniques such as grinding, lapping, and polishing may be used to finish the edges. In some embodiments, finishing involves grinding the edges of the glass article using a grinding tool made of an abrasive material such as alumina, silicon carbide, diamond, cubic boron nitride, or pumice. Grinding is done in several passes, with each successive pass possibly using a different grit size. In general, grinding starts with a high grit size and ends with a small grit size. The higher the grit number, the less aggressive is the material removal. An example sequence is a 350 grit (about 40 μm diamond grain size), followed by a 600 grit (about 24 μm diamond grain size). The grinding may involve shaping the edges of the glass article into a desired edge profile, such as a flat, round, or beveled profile. After grinding, the edges are polished using a polishing tool, which may be in the form of a wheel, pad, or brush. Abrasive particles can be loaded onto the polishing tool, where polishing would then involve rubbing or brushing the abrasive particles against the edges of the glass article. After polishing, the edges of the glass article will be smooth, e.g., surface roughness of the edges may be less than 100 nm, as measured by a ZYGO® Newview 3D optical surface profiler.

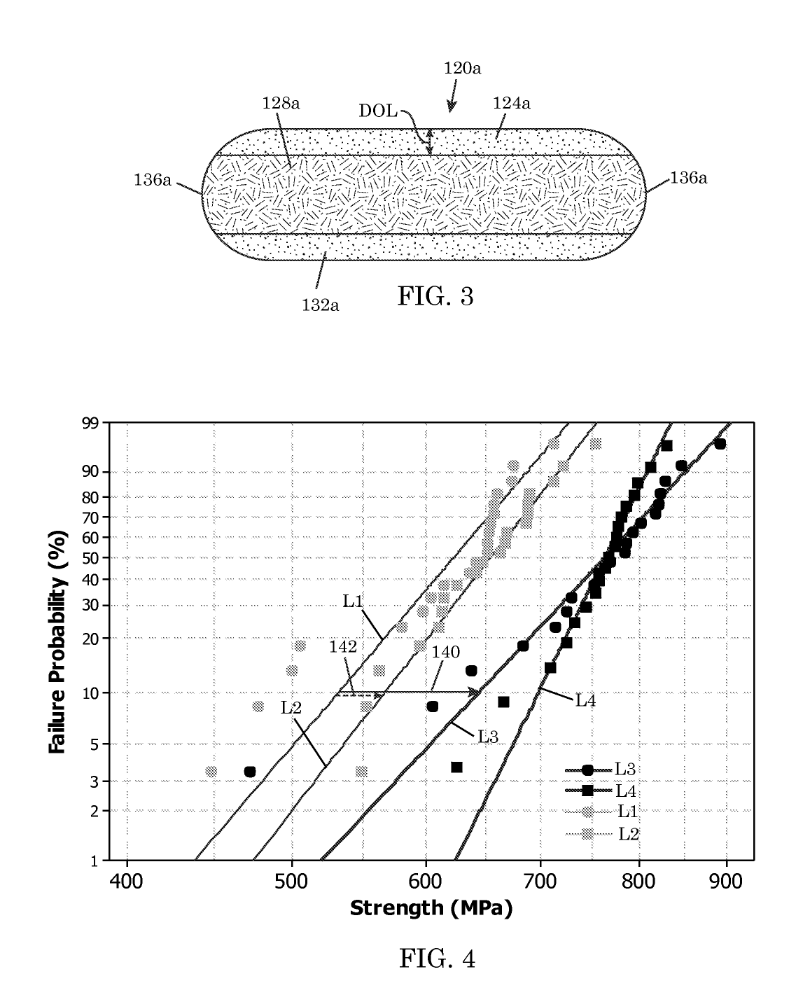

FIG. 3 shows one example glass article 120a with finished edges 136a having a round profile. The finished edge 136a, regardless of its profile, will typically have flaws induced by at least one of the separation and machining processes. At least some of these flaws will be in the portion of the tensile stress layer 128a exposed at the edges 136a. Stresses applied to the glass article 120a will not need to overcome the residual surface compression in the top and bottom compressive stress layers 124a, 132a of the glass article 120a in order to cause failure at a critical flaw located in the tensile-stressed areas of the edges 136a. This means that the overall flexural strength of the glass article 120a will be governed by the ability of the edges 136a to withstand tensile stress. As mentioned earlier, the tensile stress required for failure increases as the flaw size reduces or the stress intensity factor at the tip of the flaw decreases. Thus the ability of the edges to withstand tensile stress can be improved by reducing length and tip radius of the flaws on the finished edges 136a, which would ultimately lead to an overall increase in the flexural strength, or failure strength, of the glass article.

After the finishing, the edges of the glass article are chemically etched. The chemical etching is used to substantially reduce the length and/or tip radius of flaws on the finished edges 136a. Etching involves immersing the edges 136a in an aqueous medium containing an etchant capable of removing the glass material. Typically, the etchant will contain fluoride. The etchant can be hydrofluoric acid (HF) or a combination of HF and a mineral acid such as hydrochloric acid (HCl), nitric acid (HNO₃), sulfuric acid (H₂SO₄), phosphoric acid (H₂PO₄), and others. The etchant may be present in the aqueous medium in an amount of about 1% up to 50% by volume. The mineral acid may be present in the aqueous medium in an amount up to 50% by volume. In a preferred embodiment, an aqueous solution of HF/H₂SO₄ is used to etch the edges of the glass article.

Etching need only be for a duration to remove the roughness at the edges 136a of the glass article 120a. If the surface roughness at the edges 136a is less than 100 nm, for example, then the etching need only be for a duration to remove about 100 nm of material from the edges 136a. However, if the glass article had other flaws at the edges not due to the finishing of the edges, then the length of these surface flaws may dictate the duration of the etching. If etching does not remove all the flaws at the edges of the glass article, etching may reduce the length of the flaws and/or blunt the tips of the flaws so that the stress intensity factor at the flaws is reduced. In general, the amount of material that will be removed from the edges will be 2 μm thick or less, preferably less than 1 μm thick, more preferably less than 500 nm thick. Where such a small amount of material is removed, etching will typically be more effective in blunting the flaw tip radius rather than significantly reducing flaw length.

The idea of chemically etching a surface to remove flaws has been described in patent publications. For example, U.S. Patent Application Publication No. 2012/0052302 (“the Matusick publication”) discloses removing flaws from a separated and finished glass edge using acid etching. One of the contributions of the present disclosure is the discovery that uniaxial flexural strength of the glass article after chemical etching is influenced by the stress profile of the glass sheet from which the glass article was separated. In particular, it was found that uniaxial flexural strength in the etched glass article depended on both the compressive stress and depth of compressive stress layer in the glass sheet from which the glass article was separated.

A study was conducted to investigate the effect of compressive stress and depth of compressive stress layer on flexural strength. For the study, glass sheets having a Corning 2319 glass composition were strengthened by ion-exchange. CORNING 2319 glass can be ion-exchanged to a compressive stress of up to 900 MPa. This glass comprises at least about 50 mol % SiO₂ and at least 11 mol % Na₂O. In some embodiments, the glass further comprises Al₂O₃ and at least one of B₂O₃, K2O, MgO and ZnO, wherein −340+27.1.Al₂O₃-28.7.B₂O₃+15.6Na₂O-61.4.K₂O+8.1.(MgO+ZnO)≧0 mol %. In particular embodiments, the glass comprises from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO. The glass is described in U.S. Provisional Patent Application No. 61/503,734 by Matthew J. Dejneka et al., entitled “Ion Exchangeable Glass with High Compressive Stress,” filed Jul. 1, 2011.

For the study, different ion-exchange conditions were used such that the glass sheets had different combinations of compressive stress (CS), depth of compressive stress layer (DOL), and central tension (CT), as indicated in Table 1 below. The thicknesses of the glass sheets were held constant at 0.7 mm.

TABLE 1

| Glass Sheet | CS (MPa) | DOL (μm) | CT (MPa) |
|---|---|---|---|
| G1 | 450 | 28 | 20 |
| G2 | 450 | 40 | 29 |
| G3 | 650 | 28 | 28 |
| G4 | 650 | 40 | 42 |

Glass samples were separated from the glass sheets. The edges of the samples were finished and then chemically-etched. Uniaxial flexural strengths of the glass samples were measured using a horizontal four-point bend test. The results are shown in FIG. 4 as a plot of failure probability in percent versus flexural strength in MPa. Lines L1, L2, L3, and L4 are fitted to the data. Each of lines L1, L2, L3, and L4 corresponds to glass samples obtained from glass sheets G1, G2, G3, and G4, respectively. The results are based on Weibull statistics. Weibull modulus of the data represented by each of lines L1, L2, L3, and L4 is shown in Table 2 below. Weibull modulus is a dimensionless metric that is used to compare the consistency of strength data from a sample population. It is the slope of a log-log plot of failure probability versus measured strength values. If the measurements show high variation, the calculated Weibull modulus will be low. On the other hand, if the measurements show low variation, the calculated Weibull modulus will be high.

TABLE 2

| | | | | CS*DOL | Weibull |
|---|---|---|---|---|---|
| Line | CS (MPa) | DOL (μm) | CT (MPa) | (μm-MPa) | Modulus |
| L1 | 450 | 28 | 20 | 12,600 | 12.09 |
| L2 | 450 | 40 | 29 | 18,000 | 13.15 |
| L3 | 650 | 28 | 28 | 18,200 | 11.05 |
| L4 | 650 | 40 | 42 | 26,000 | 21.01 |

The plot of FIG. 4 shows that at low failure probabilities, e.g., below 25% failure probability, flexural strength increases as compressive stress increases. The plot also shows that at low failure probabilities, e.g., below 25% failure probability, flexural strength increases as depth of compressive stress layer increases. Both high compressive stress and high depth of compressive stress layer are needed to achieve high flexural strength. However, compressive stress achieves a greater shift in flexural strength than depth of compressive stress layer. Line 140 shows the shift in flexural strength achieved at 10% failure probability by increasing the compressive stress from 450 MPa to 650 MPa while keeping the depth of compressive stress layer constant at 28 μm. For comparison, line 142 shows the shift in flexural strength achieved at 10% failure probability by increasing the depth of compressive stress layer by 12 μm while keeping the compressive stress at 450 MPa. It should be noted that line 142 is placed slightly below line 140 so that it is easier to see both lines. As can be observed, the shift in flexural strength represented by line 140 is much higher than the shift in flexural strength represented by line 142. Table 2 above shows the product of compressive stress and depth of compressive layer. The data shows that as this product increases, flexural strength increases.

There is also a relationship between flexural strength and central tension due to central tension being a function of compressive stress and depth of compressive stress layer. However, the relationship is nonlinear. For example, consider lines L2 and L3 that represent glass samples with virtually the same central tension but significantly different flexural strengths. In general, high flexural strength is associated with a combination of high central tension and high compressive stress.

The discovery that flexural strength is influenced by compressive stress and depth of compressive stress layer is useful. Based on this discovery, experimental studies can be carried out to determine an approximate relationship between flexural strength, compressive stress, and depth of compressive stress layer for a particular glass thickness or alternately between flexural strength and central tension, which would automatically incorporate compressive stress, depth of compressive stress layer, and glass thickness information. From the relationship, it would be possible to determine a combination of compressive stress and depth of the compressive layer necessary to achieve a desired flexural strength at a desired glass thickness. To make a glass article having the desired flexural strength, the procedure would then be to make a strengthened glass sheet having the determined combination of compressive stress and depth of the compressive layer, within an acceptable error of margin, separate a glass article from the glass sheet, finish the edges of the glass article, and chemically etch the separated and finished edges of the glass article.

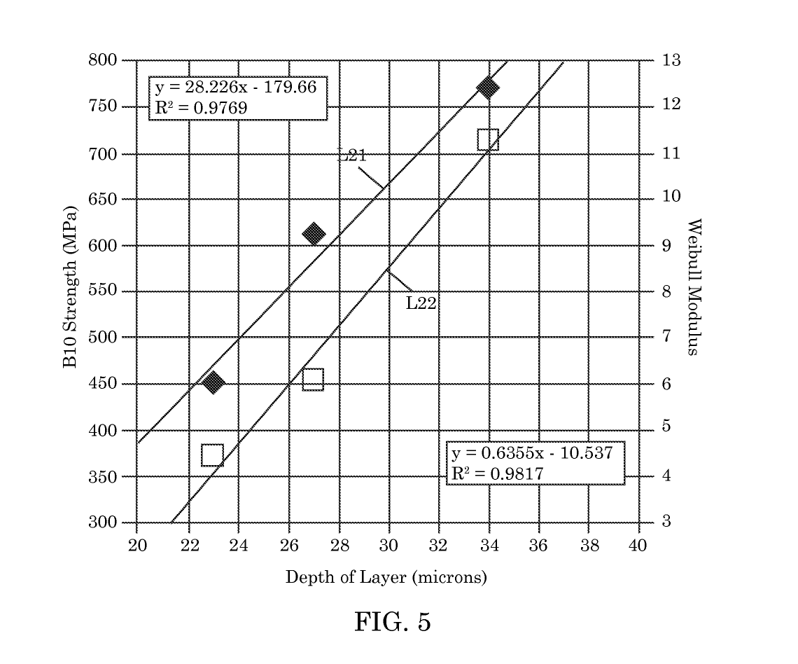

FIG. 5 is another plot based on experimental studies of glass samples obtained from strengthened alkali aluminosilicate glass sheets having a Corning 2319 glass composition. The plot shows B10 Strength in MPa as a function of depth of compressive stress layer in μm. Line L21 is fitted through the B10 Strength versus depth of compressive stress layer data. The compressive stress was fairly constant for the measured data at a range of 675 to 715 MPa. The results show that the B10 Strength increases as the depth of compressive stress layer increases. The B10 Strength is the flexural strength at the 10% failure probability. This means that 10% of the sample population will have a strength below this value and 90% will have a strength above this value. The plot of FIG. 5 also shows the Weibull modulus. Line L22 is fitted through the Weibull modulus data.

In certain embodiments, the strengthened glass sheet 100 (in FIG. 1) has a product of depth of compressive stress layer and compressive stress greater than 21,000 μm-MPa, preferably greater than 22,750 μm-MPa, and more preferably greater than 23,500 μm-MPa. In addition, the depth of compressive stress layer is at least 31 μm, preferably greater than 35 μm, and more preferably greater than 39 μm. In addition, compressive stress is greater than 600 MPa, preferably at least 650 MPa, and more preferably greater than 700 MPa. The glass sheet thickness is in a range from 0.2 mm to 2 mm, preferably less than 1.2 mm, more preferably in a range from 0.7 mm to 1.0 mm. Preferably, the strengthened glass sheet is substantially free of surface flaws of a depth greater than 5 μm. More preferably, the strengthened glass sheet is substantially free of surface flaws of a depth greater than 2 μm. The glass sheet may be made by a fusion down-draw process or other suitable method for making flat glass. The glass sheet may be strengthened by chemical tempering or thermal tempering.

Preferably, the glass sheet is strengthened by low-temperature ion-exchange method. The depth of compressive stress layer achievable with low-temperature ion-exchange is typically limited to about 100 μm. If the glass sheet is to be strengthened by ion-exchange, it would need to be an ion-exchangeable glass. For high strength applications such as cover glass applications, the glass sheet is preferably an alkali aluminosilicate glass, which is also an ion-exchangeable glass. In one embodiment, the glass sheet may have a CORNING 2319 glass composition, as described above. Additional ion-exchangeable glass compositions are described in U.S. Pat. No. 7,666,511 (Ellison et al; 20 Nov. 2008), U.S. Pat. No. 4,483,700 (Forker, Jr. et al.; 20 Nov. 1984), and U.S. Pat. No. 5,674,790 (Araujo; 7 Oct. 1997); U.S. patent application Ser. No. 12/277,573 (Dejneka et al.; 25 Nov. 2008), Ser. No. 12/392,577 (Gomez et al.; 25 Feb. 2009), Ser. No. 12/856,840 (Dejneka et al.; 10 Aug. 2010), Ser. No. 12/858,490 (Barefoot et al.; 18 Aug. 18, 2010), and Ser. No. 13/305,271 (Bookbinder et al.; 28 Nov. 2010).

CORNING 2317 glass is another example of an alkali aluminosilicate glass that can be ion-exchanged. CORNING 2317 glass comprises from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol % Li₂O+Na₂O+K₂O 20 mol % and 0 mol % MgO+CaO≦10 mol %. The glass is described in U.S. Pat. No. 8,158,543 by Sinue Gomez et al., entitled “Fining Agents for Silicate Glasses,” filed Feb. 25, 2009, and claiming priority to U.S. Provisional Patent Application No. 61/067,130, filed on Feb. 26, 2008.

CORNING 2318 glass is another example of an alkali aluminosilicate glass that can be ion-exchanged. CORNING 2318 glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ. In some embodiments, the alkali aluminosilicate glass comprises from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO. The glass is described in U.S. patent application Ser. No. 12/856,840 by Matthew J. Dejneka et al., entitled “Zircon Compatible Glasses for Down Draw,” filed Aug. 10, 2010, and claiming priority to U.S. Provisional Patent Application No. 61/235,762, filed on Aug. 29, 2009.

In certain embodiments, strengthening of the glass sheet by ion-exchange can be carried out in a molten salt bath containing larger cations that will replace smaller cations within the glass. The larger cations will have the same valence or oxidation state as the smaller cations. Typically, these cations will be single-charged or double-charged monoatomic ions, e.g., alkali-metal or alkaline-earth-metal ions. The glass sheet is immersed in the molten salt bath, and the exchange of ions take place at the surface of the glass sheet to a certain depth into the glass sheet. Choice of exchanged ions, temperature of the bath, and immersion time of the glass sheet will affect the compressive stress created in the glass sheet and the depth of the compressive stress layer in the glass sheet. Experimental studies can be carried out to determine the appropriate molten salt bath temperature and glass sheet immersion time for a particular glass composition and exchanged ions. Typically, the temperature of the molten salt bath will be between 380° C. and 450° C. The immersion will typically be several hours.

In certain embodiments, one or more glass articles 120 (in FIG. 2) are separated from the strengthened glass sheet 100 (in FIG. 1). After the separation, each of the glass articles has at least one edge with exposed tensile stress layer. The edges of each of the glass articles are finished by machining. After the finishing, the edges of each of the glass articles are chemically etched. The glass article after etching has a top surface region with compressive stress, an inner core region with tensile stress, and a bottom surface region with compressive stress, where the inner core region is adjacent to both the top and bottom surface regions. The inner core region is also exposed at the edges of the glass article, where the edges of the glass article have been chemically etched as described above.

A glass article prepared as described above may exhibit one or more of the properties described below.

In some embodiments, the uniaxial flexural strength of the glass article is in excess of 600 MPa, where uniaxial flexural strength is measured by a horizontal four-point bend test.

In some embodiments, a product of the compressive stress in the (top or bottom) compressive stress layer and the depth of the (top or bottom) compressive stress layer is greater than 21,000 μm-MPa, preferably greater than 22,750 μm-MPa, and more preferably greater than 23,500 μm-MPa.

In some embodiments, the depth of the (top or bottom) compressive stress layer is at least 31 μm, preferably greater than 35 μm, and more preferably greater than 39 μm.

In some embodiments, the compressive stress in the (top or bottom) compressive stress layer is at least 600 MPa, preferably greater than 650 MPa.

In some embodiments, the glass article is an alkali aluminosilicate glass.

In some embodiments, the glass article has uniform thickness in a range from 0.2 mm to 2 mm, preferably less than 1.2 mm, more preferably in a range from 0.7 mm to 1 mm.

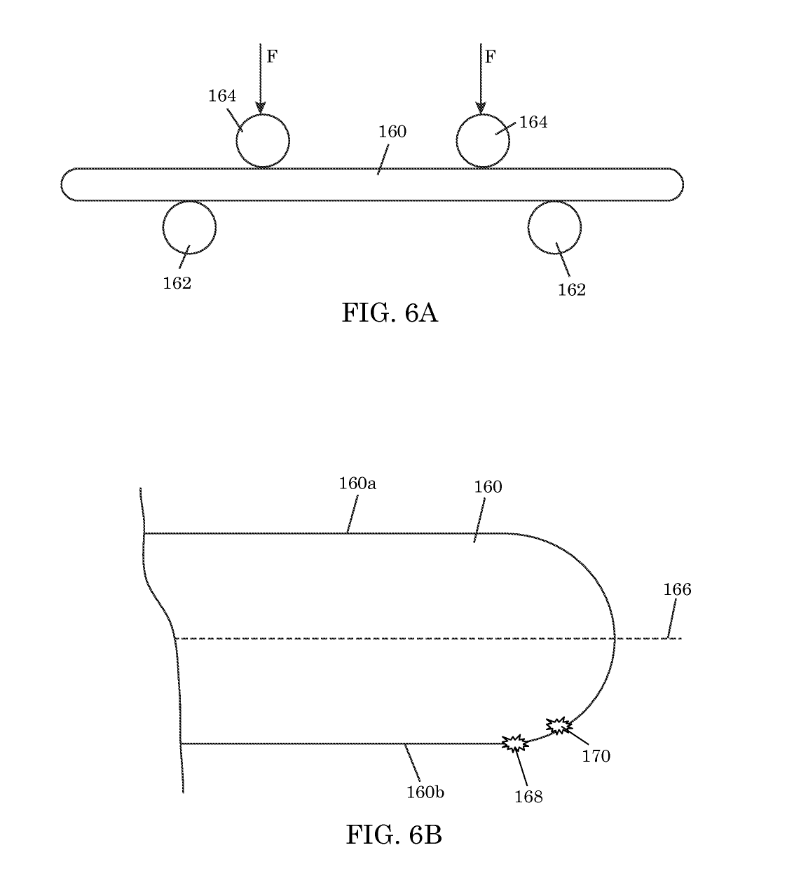

Glass articles were prepared as described above from a strengthened glass sheet having a compressive stress greater than 650 MPa and a depth of compressive stress layer greater than 35 μm. These glass articles were subjected to the horizontal four-point bend test in order to determine their uniaxial flexure strengths. FIG. 6A shows a setup for a horizontal four-point bend test. A glass article 160 is supported on a pair of rollers 162. Another pair of rollers 164 is arranged on top of the glass article 160. The rollers 162, 164 are arranged symmetrically about the centerline of the glass article 160, with the rollers 164 in between the rollers 162. Loads F are applied to the top rollers 164 to create two opposing moments on either side of the centerline of the glass article 160. The opposing moments result in constant bending stress in the glass article 160. The applied loads F are increased until the glass article fails. The maximum tensile stress within the glass article 160 at the time the glass article fails determines the uniaxial flexural strength of the glass article. FIG. 6B shows a cross-section of the glass article 160 in uniaxial flexure. The maximum compressive stress occurs at the top surface 160a where the load is applied, and the maximum tensile stress occurs at the bottom surface 160b just opposite to the load direction. In between the top and bottom surfaces 160a, 160b is a neutral axis 166 where stress is zero.

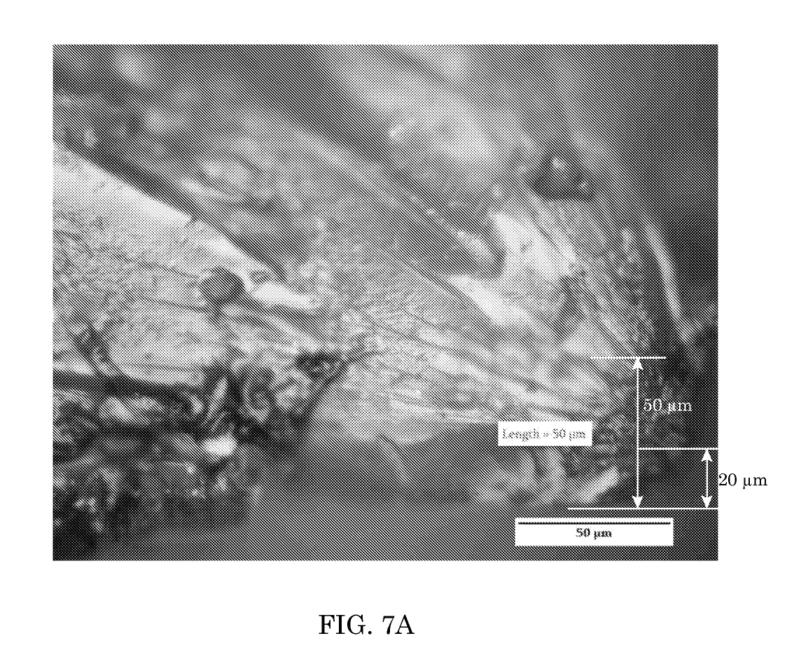

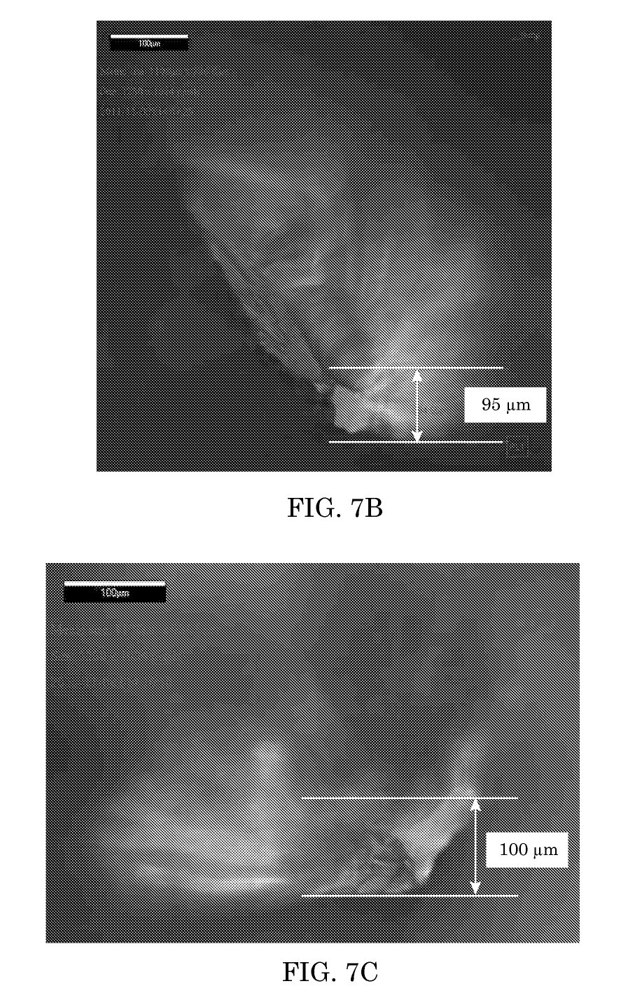

FIGS. 7A-7C show three fractured surfaces produced by the test. Interestingly, in each of the fractured surfaces, the failure location is displaced from the outer fibers where maximum flexural tensile stress would be located during uniaxial flexure towards where the neutral axis would be located during uniaxial flexure by 20 μm, 95 μm, and 100 μm, respectively. Normally, failure should occur at the outer fibers where the maximum tensile stress occurs. The expected failure location is illustrated at 168 in FIG. 6B. The actual failure location is illustrated at 170 in FIG. 6B. The offset between the expected failure location and actual failure location is in a range from 20 μm to 100 μm for the results shown in FIGS. 7A-7C. The displacement of the failure location in FIGS. 7A-7C is believed to be due to the selected combination of the compressive stress and depth of compressive stress layer of the glass sheet and chemical etching of the flaws at the edges of the glass articles. This is important because if the failure location is not at the outer fibers where the maximum tensile stress is located, it means that the glass article will be able to withstand higher tensile stress before failure, which means increased uniaxial flexural strength.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A strengthened glass article having a chemically-etched edge and a compressive stress layer formed in a surface region thereof, the compressive stress layer having a compressive stress and a depth of layer, wherein a product of the compressive stress and depth of layer is greater than 21,000 μm-MPa.

2. The strengthened glass article of claim 1, which has a uniaxial flexural strength in excess of 600 MPa.

3. The strengthened glass article of claim 1, wherein the depth of layer is at least 31 μm.

4. The strengthened glass article of claim 1, wherein the compressive stress is greater than 600 MPa.

5. The strengthened glass article of claim 1, wherein the compressive stress is at least 650 MPa and the depth of layer is greater than 35 μm.

6. The strengthened glass article of claim 1, which has a failure location under uniaxial flexure displaced from outer fiber flexural tensile stress by at least 20 μm.

7. The strengthened glass article of claim 1, which has a thickness in a range from 0.2 mm to 2 mm.

8. The strengthened glass article of claim 1, which is an alkali aluminosilicate glass.

9. A method of making a strengthened glass article, comprising:
creating a compressive stress layer in a glass sheet such that a product of a compressive stress in the compressive stress layer and a depth of the compressive stress layer is greater than 21,000 μm-MPa;
separating a glass article from the glass sheet; and
chemically etching at least one edge of the glass article.

10. The method of claim 9, wherein creating the compressive stress layer comprises subjecting the glass sheet to an ion-exchange process.

11. The method of claim 9, wherein the glass sheet is an alkali aluminosilicate glass.

12. The method of claim 9, wherein chemically etching comprises blunting tips of flaws in the at least one edge of the glass article.

13. The method of claim 9, wherein chemically etching comprises removing a material thickness of 2 μm or less from the at least one edge of the glass article.
